(19) United States
(12) Patent Application Publication
(10) Pub. No.: US 2011/0036331 A1
(43) Pub. Date: Feb. 17, 2011

(54) Supercharger system for two-stroke engines

(76) Inventor: Milton Russell Pocha, Kamloops (CA)

Correspondence Address: Antony C. Edwards, Unit 206 - 3500 Carrington Road, Westbank, BC, V4T 3C1, CA

(21) Appl. No.: 12/805,665

(22) Filed: Aug. 12, 2010

Related U.S. Application Data
(60) Provisional application No. 61/233,405, filed on Aug. 12, 2009.

(51) Int. Cl. F02B 33/00

(52) U.S. Cl. 123/559.1

(57) ABSTRACT

A supercharger system for a two-stroke internal combustion engine includes a gearbox, compressor, airbox and an exhaust flow restrictor. The compressor may be a belt driven impeller to create positive pressure to the engine air intake. Restricting the flow of the exhaust slows down the exhaust to inhibit blow-through in the combustion chamber which would prematurely force unburned air and fuel from the combustion chamber of the engine. The gearbox is self-lubricating and contains only two gears and an internal reservoir arranged using a metering conduit so that consistent lubrication occurs at higher angles of inclination when the engine is in use.

### CROSS REFERENCE TO RELATED APPLICATION

This application claims priority from U.S. Provisional Patent Application No. 61/233,405 filed Aug. 12, 2009 entitled Two Stroke Internal Combustion Engine Supercharger.

### FIELD OF THE INVENTION

This invention relates to the field of superchargers for internal combustion engines and in particular to a supercharger system solely for two-stroke internal combustion engines.

### BACKGROUND OF THE INVENTION

So-called four stroke internal combustion engines ignite the fuel and air mixture in their cylinders every second revolution, with the intake and exhaust of the gases in the combustion chamber being controlled by mechanically driven valves. Two stroke engines however ignite their combustion chamber on every stroke. The movement of the piston itself opens and closes intake and exhaust ports. This provides two stroke engines with a greater power to weight ratio as compared to four stroke engines.

Superchargers for four stroke engines are known in the prior art. The use of valves in four stroke engines allows the engine to hold the air in the engine's detonation chamber until the exhaust valve opens to clear the exhaust.

Unlike a four stroke engine, a two stroke engine does not have a valve to regulate the expulsion of the exhaust gases from the combustion chamber. Rather, the movement of the piston opens ports for the intake and exhaust gases to flow in and out of the combustion chamber. When the piston allows the intake gases (air and fuel) into the cylinder, it is possible for these to be simultaneously expelled through the exhaust port.

Providing pressurized air, or boost, to a two stroke engine is inherently difficult due to the design and function of a two stroke engine. The boost may push the unburned air and fuel out through the open exhaust port, effectively stalling the engine or creating considerably diminished engine performance.

In recent years, turbocharger units have been developed for two stroke engines. These provide boost on a positive feedback system based upon an impeller driven by the expulsion of the exhaust gases. The impeller then pressurizes the air in the intake system. As the turbocharger is driven by the expulsion of exhaust gases, the turbocharger itself provides the resistance or back pressure necessary to hold the boost in the combustion chamber until the fuel/air mixture in the combustion chamber has been burned.

Due to the use of exhaust to drive a turbocharger unit, the boost created in these systems is often felt to have a delay, or “lag”. Because of the inherent positive feedback system, increased exhaust gases from increased throttle must drive the impeller, which in turn begins to pressurize the air to the engine, which creates more power and more exhaust gases, which then turns the impeller at a greater rate. This time lag, between increased throttle and the engine's response to it, is quite pronounced in some systems.

The revolutions-per-minute (RPM) of the turbocharger impeller also fluctuates, as then does the boost, in relation to the throttle position, rather than the engine RPM. For example, boost pressure at 5000 engine RPM would vary greatly between fully closed and wide open throttle positions, due to the amount of exhaust gases available to drive the impeller. Thus, impeller RPM can vary greatly for any given engine RPM, which is a further drawback of turbochargers. Further, conventional turbocharger systems are relatively large and often use cast iron components, consequently diminishing the power to weight ratio advantage of a two stroke engine.

A supercharger on the other hand, provides boost directly related to engine RPM. As a mechanically driven system, the RPM of the impeller wheel is directly related to engine RPM, thus an increase in throttle provides greater immediate impeller RPM, which pressurizes the air available to the engine. Regardless of throttle position, the supercharger impeller RPM will be consistent at a given engine RPM. This creates improved throttle response, and consistent performance measures throughout the engine's RPM range.

### SUMMARY OF THE INVENTION

The supercharger system according to the present invention is specifically for a two-stroke internal combustion engine and includes a compressor, airbox and associated intake, and an exhaust flow restrictor. The compressor is a belt driven impeller, which forces outside air through the intake to create positive pressure, or “boost” to the engine air intake. By restricting the flow of the exhaust, the flow restrictor assembly slows down the exhaust in order that the boost to the combustion chamber does not prematurely force unburned air and fuel from the combustion chamber of the engine.

The two stroke supercharger system according to the present invention has been developed as a means through which to increase the performance of an internal combustion two stroke engine. Application of the present invention may include, without intending to be limiting, snowmobiles, personal watercraft, go-carts, all terrain vehicles, and motorbikes, etc.

In summary the system for supercharging a two stroke engine according to one aspect of the present invention may be characterized as including a supercharger having an improved gear assembly, and a flow restrictor to inhibit blow-through of the fuel/air mixture in the engine combustion chambers.

The supercharger is adapted for mounting directly on to the two stroke engine, that is, not to the vehicle frame, etcetera, and so as to cooperate with the engine. The supercharger is adapted to be driven directly from the crank of the engine, for example by a drive pulley and belt system. The supercharger has a gear case containing a gear train consisting of only first and second intermeshing gears. One aspect of the present invention resides in the efficiency of having only two self-lubricating gears in a self-contained gear case.

The first gear is coupled to the engine crank. A compressor is mounted within a compressor housing. The compressor housing is mounted on the gear case. The compressor is coupled to the second gear for co-axial rotation therewith. The first and second gears intermesh at a nip and mate in a corresponding intermeshing zone between the gears, so that the first gear drives the second gear. The compressor is in fluid communication with an air intake of the engine. The gear case has first and second gear cavities overlapping at the intermeshing zone. The first and second gears are mounted, respectively, in the first and second gear cavities. The first and second gear cavities are sized for snug nesting of the first and second gears into the first and second cavities respectively.

The gear case has an oil reservoir formed therein. The gear case further includes an oil metering conduit formed in fluid communication between the oil reservoir and the first gear cavity, whereby oil in the reservoir flows into the first gear cavity. Rotation of the first gear conveys oil from the oil metering conduit around a circumferential wall segment of the first gear cavity to thereby convey the oil to the nip and through the intermeshing zone. The gear case is further formed to provide an oil skimmer and oil recirculating channels for recapturing and recirculating oil from the first and second gear cavities to the oil reservoir.

An exhaust flow restrictor is adapted for mounting into the exhaust conduit of the engine. The flow restrictor is adapted to regulate exhaust outflow through the exhaust conduit in response to exhaust volume and exhaust pressure from the engine. The exhaust flow restrictor is thereby adapted to provide a backpressure into the combustion chambers of the engine to inhibit blow-through into the exhaust of unburnt fuel/air mixture from the combustion chambers, where the blow-through is caused by boost pressure from the compressor into the air intake of the engine which is not counter-balanced by back pressure in the exhaust outflow.

In one embodiment the first and second gear cavities and the oil reservoir are all substantially co-planar, and the oil skimmer and the oil recirculating channels are also substantially co-planar with the first and second gear cavities and the oil reservoir. At least a first oil recirculating channel extends in fluid communication between the first gear cavity and the oil reservoir. At least a second oil recirculating channel may be provided which extends in fluid communication between the second gear cavity and the oil reservoir. Further oil conduits, for example having a 1/16 inch diameter, extend from at least one of the gear cavities into the bearing cavities corresponding to each gear cavity.

The oil skimmer may advantageously include at least a first vertice, where the first vertice is formed at a vertex of a wall segment of the first gear cavity and the entrance to the first oil recirculating channel. The first vertice may be aligned pointed substantially in a first counter-flow direction relative to a forward flow direction of oil during the conveying of the oil in the first gear cavity under the influence of rotation of the first gear. The oil skimmer may also include at least a second vertice, where the second vertice if formed at a vertex of a wall segment of the second gear cavity and the entrance to the second oil recirculating channel. The second vertice may be aligned pointed substantially in a second counterflow direction relative to a forward flow direction of oil during conveying of the oil in the second gear cavity under the influence of rotation of the second gear when driven by the rotation of the first gear.

The entrances to the first and second oil recirculating channels may be spaced apart, and at least one of the entrances may be located at the overlap between the gears. In particular, the entrance to the first oil recirculating channel may be located at a downstream end of the overlap between the gears. The entrance to the first oil recirculating channel may include an opposite vertice, oppositely disposed to the first vertice on an opposite side of the entrance to the first oil recirculating channel, where the opposite vertice is formed along a wall segment of the second gear cavity. The first and second oil recirculating channels may thus define an island therebetween, where the island, and opposite side walls of the channels opposite to the island, form smoothly contoured flow paths for the oil. In one embodiment the channels converge from the entrances to opposite downstream ends of the channels, opposite the entrances. The downstream ends are in fluid communication into the oil reservoir.

The oil reservoir may be located adjacent the first and second gear cavities. The oil metering conduit has an entrance port and an outflow port. The entrance port is located at the oil reservoir and the outflow port is located at an upstream end of the wall segment of the first gear cavity, upstream relative to the forward flow direction in the first gear cavity. The oil metering conduit is adjacent the outflow port and aligned substantially tangentially to the upstream end of the wall segment so as to direct outflow of oil from the outflow port substantially tangentially to and in the forward flow direction in the first gear cavity. In one embodiment the oil metering conduit may be substantially linear.

In a preferred embodiment the flow restrictor is a valve. The valve has an open and a closed position, and variable positions therebetween. In the closed position, the exhaust outflow is minimized. In the open position, the exhaust outflow is maximized. The valve is positioned within the variable positions between the open and closed positions so as to timely provide the back pressure to inhibit the blow-through and to also allow timely outflow of the exhaust for aspiration of the engine. The valve may be variably and automatically biased throughout a range of positions so as to automatically provide a variable back-pressure in response to at least one engine output. The output may include one of exhaust volume, flow rate and pressure.

The valve may be resiliently biased by a resiliently biasing force towards the closed position. The exhaust output urges the valve towards the open position against the return resiliently biasing force. Adjustable stops may be provided, adapted to be mounted to the exhaust conduit, so as to cooperate with the valve for selective adjustment of the range of the variable positions between the open and closed positions.

### BRIEF DESCRIPTION OF THE DRAWINGS

In the following drawings wherein like referenced numerals denote corresponding parts in each view:

FIG. 1 is a diagrammatic view of a two stroke internal combustion engine with the supercharger system according to the present invention mounted thereon.

FIG. 2 is, in perspective view, the engine and supercharger system of FIG. 1.

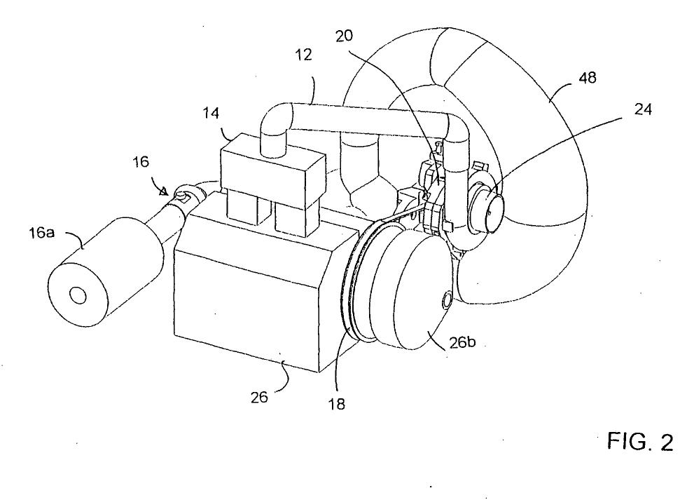

FIG. 3a is, in front right perspective view, the engine and supercharger system of FIG. 2.

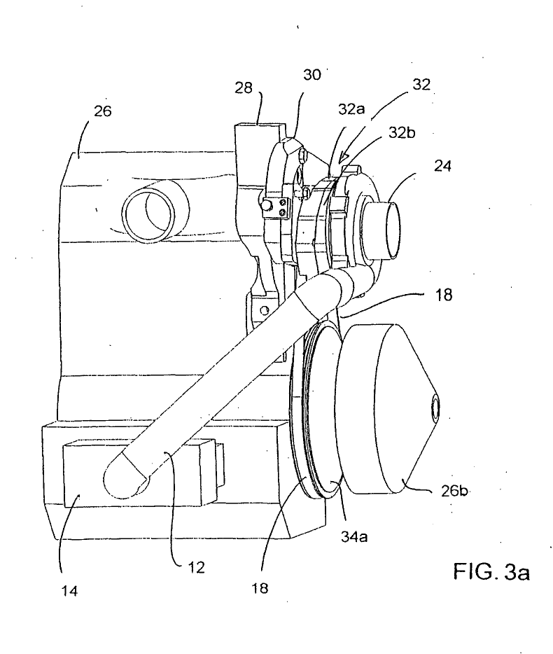

FIG. 3b is, in left front perspective view, the engine and supercharger system of FIG. 2.

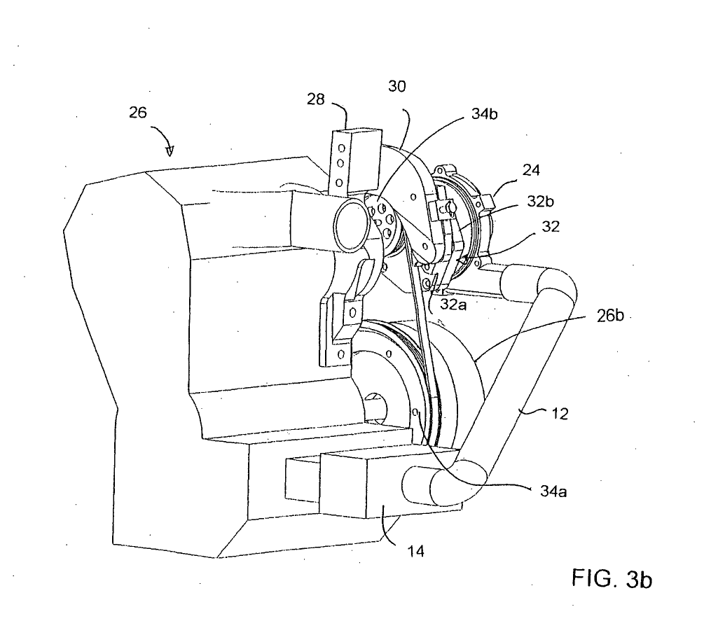

FIG. 4 is, in right side perspective view, the mounting assembly, upper drive pulley, gear case, and compressor unit of the supercharger of FIG. 3.

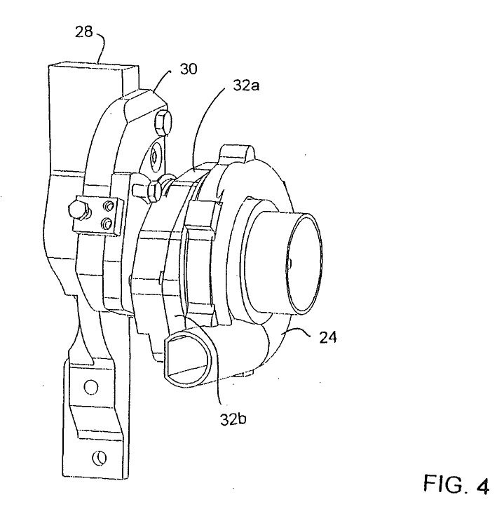

FIG. 5 is, in partially cutaway view, the supercharger assembly of FIG. 4, with the turbine housing and mounting plate removed.

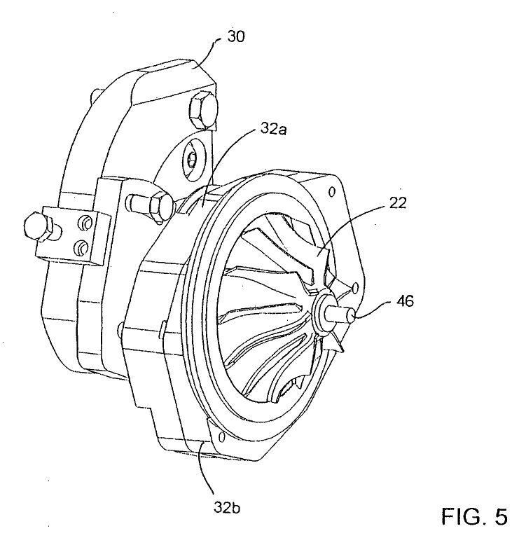

FIG. 6 is, in left side perspective partially exploded view, the gear case of the supercharger of FIG. 5 with the two halves of the gear case split apart.

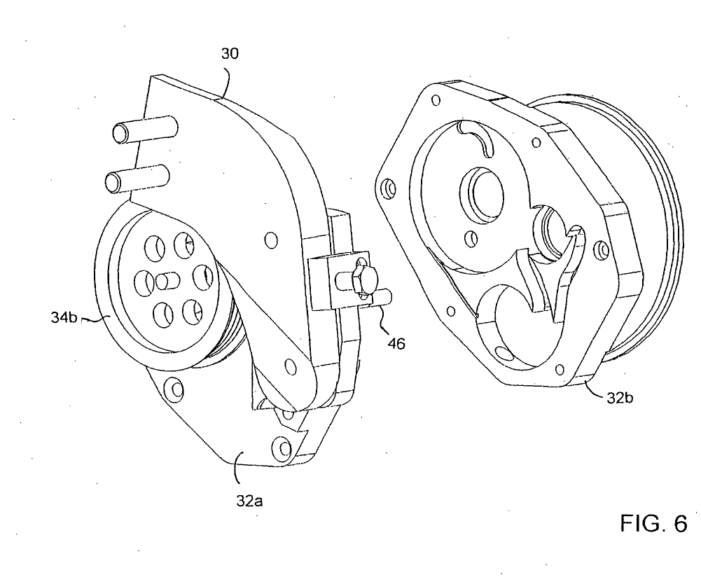

FIG. 7 is, in right side perspective view, one half of the gear case of FIG. 6, showing the gear train.

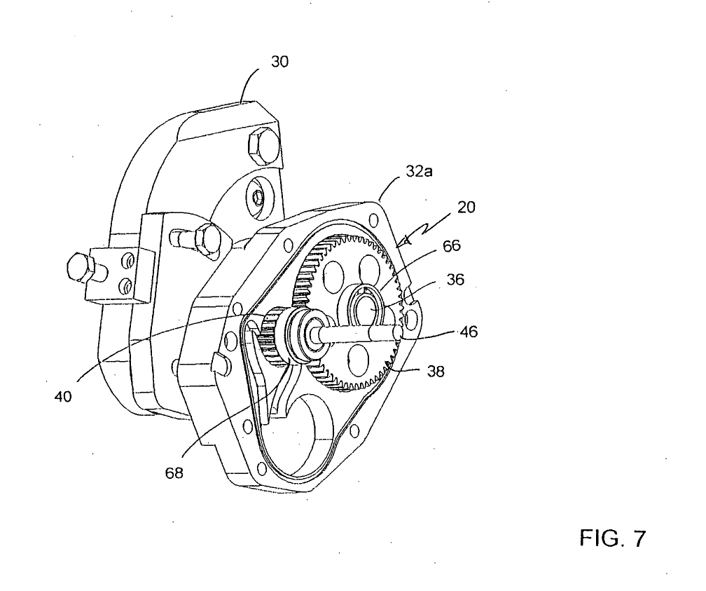

FIG. 8 is, in right side partially exploded perspective view, the gear case of FIG. 5 with the impellor removed from the impellor drive shaft.

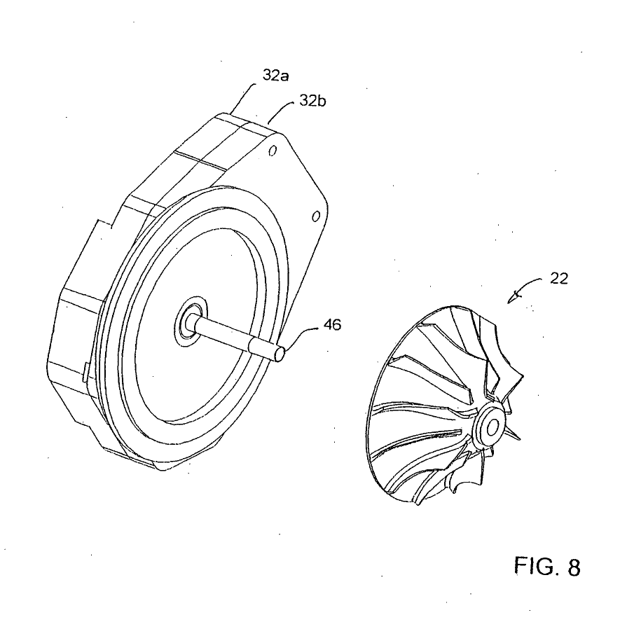

FIG. 9 is, in left side perspective view, one half of the gear case containing the drive train.

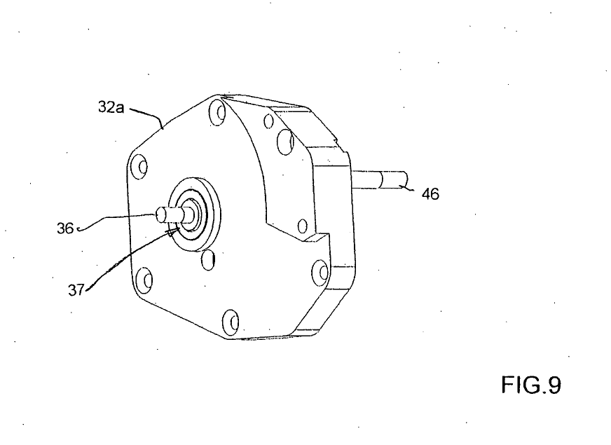

FIG. 10 is, in right side elevation view, the one half of the gear case and the drive train of FIG. 7.

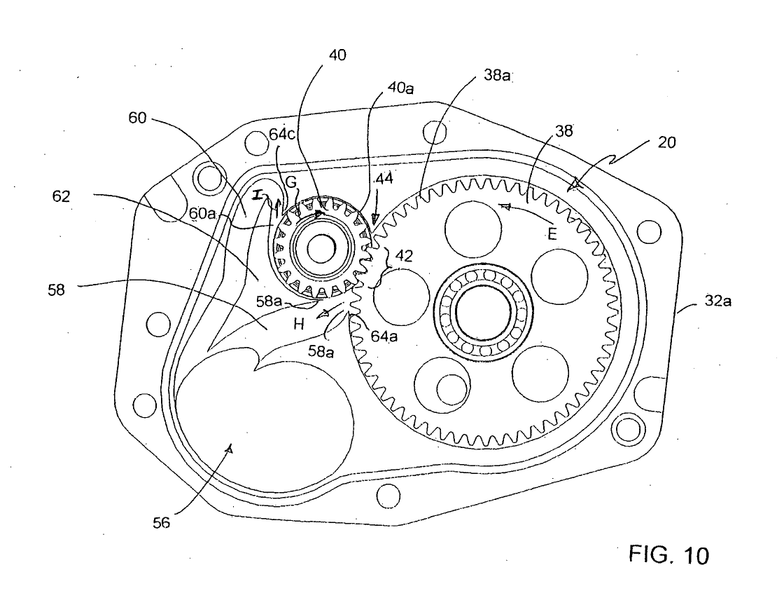

FIG. 11 is, in rear perspective view, the one half of the gear casing shown in FIG. 6 split apart from the half of the gear casing containing the drive train.

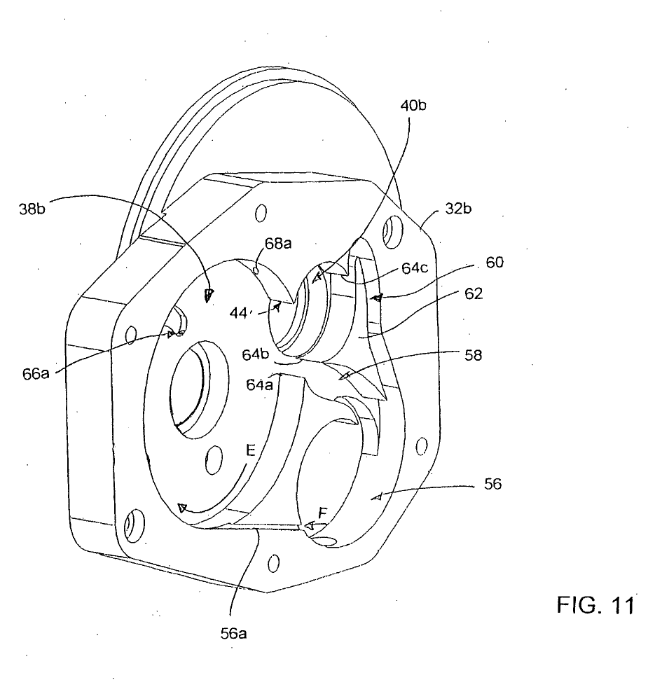

FIG. 12 is, in lower perspective view, the one half of the gear casing of FIG. 11.

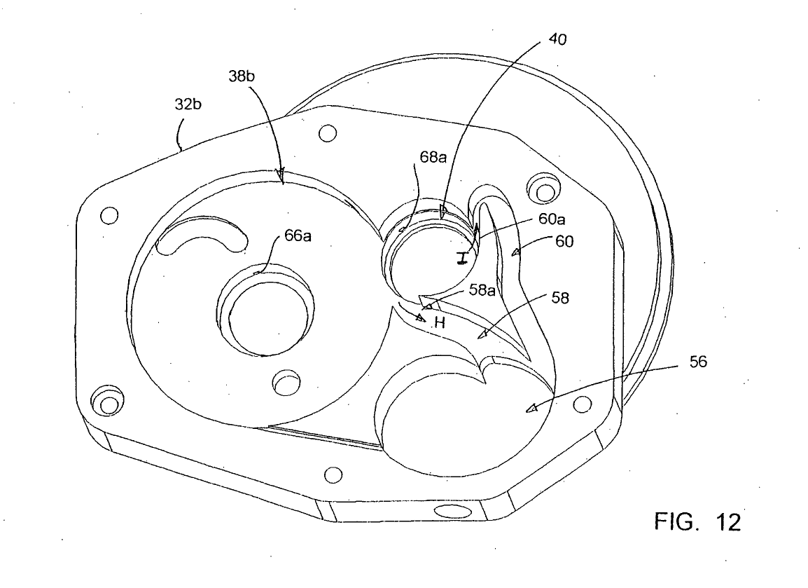

FIG. 13 is, in partially cut away perspective view, the flow restrictor assembly of the exhaust system of FIG. 2.

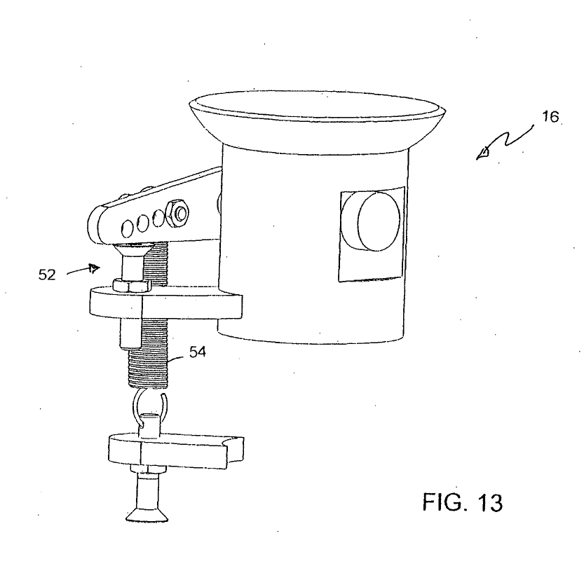

FIG. 14 is, in further partially cut away front perspective view, the flow restrictor assembly of FIG. 13 showing the offset butterfly valve mounted for rotation on an axle within the exhaust system, and biased for rotation about the axle by a spring biased bell crank arm.

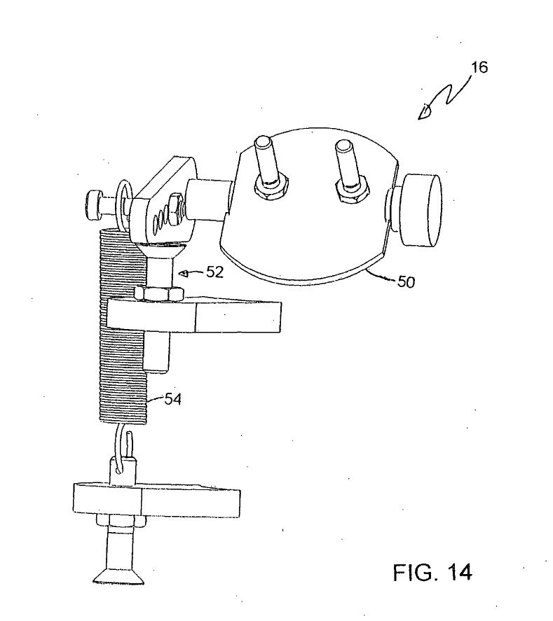

FIG. 15 is, in side elevation view, the flow restrictor assembly of FIG. 14.

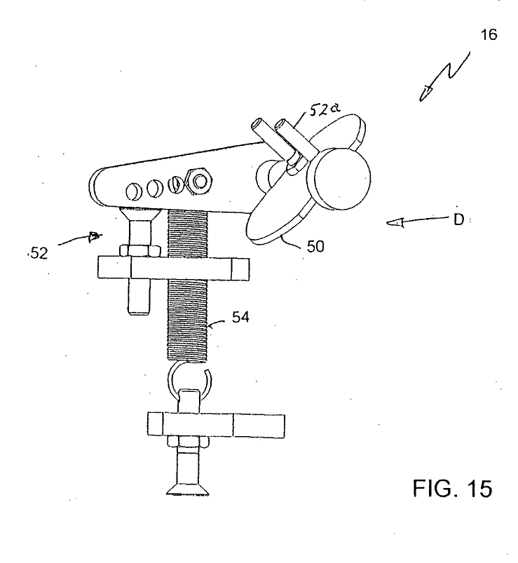

### DETAILED DESCRIPTION OF EMBODIMENTS OF THE INVENTION

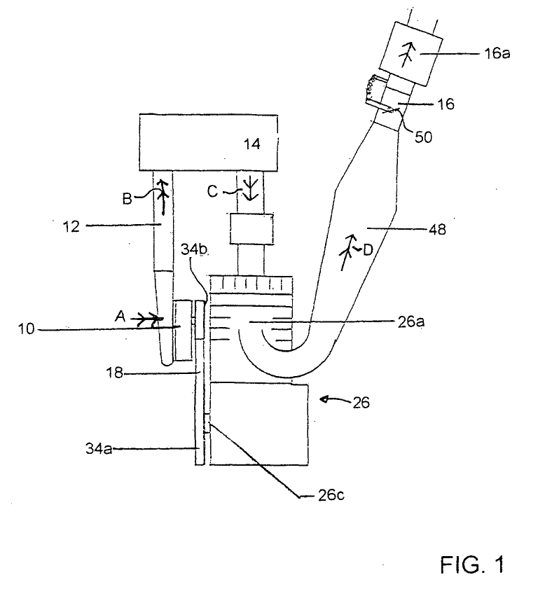

The two-stroke internal combustion engine supercharger system according to the present invention illustrated diagrammatically in FIG. 1 includes a compressor unit 10, air intake 12 and airbox 14, and exhaust flow restrictor 16.

A drive belt 18 drives gear assembly 20 to spin an impeller 22. The impeller scavenges outside ambient air (see airflow in direction A) and pressurizes, or boosts, the airflow through a turbine housing 24, which then passes through in direction B, airway of air intake 12, and subsequently through airbox 14 which divides the boosted air flow in direction C into the combustion chamber 26a for each of the cylinders of two-stroke engine 26.

Compressor unit 10 consists of a main mount 28, adaptor plate 30, gear drive or assembly 20, gear housing 32, large drive pulleys 34a, small drive pulley 34b, drive belt 18, impeller 22 and turbine housing 24.

The main mount 28 is used to locate the compressor unit on one side, for example the front left side of the engine 26 and for example using the existing engine mount (so long as on the engine itself), existing engine accessory brackets, electric starter mounting location, or available threaded mounting points on the engine block. The main mount 28 is mounted directly or indirectly on to the engine 26, so that engine vibration or movement of the engine due to engine torque does not affect the orientation or alignment of the compressor unit 10, and in particular the alignment of the drive pulleys 34a, 34b.

The adapter plate 30 provides for the mounting of a standard sized gear housing 32 to the main mount 28, as well as acting to properly align the drive pulleys 34a, 34b to another. The gear housing 32 also carries drive pulley 34b, impeller 22, and turbine housing 24.

The drive pulleys 34a, 34b and drive belt 18 mechanically tie the compressor unit 10 to the engine 26. Small drive pulley 34b is mounted to the input shaft 36 of gear drive 20. Input shaft 36 drives the larger gear 38 of the two gears 38 and 40 mounted within gear housing 32. The larger gear 38 drives the smaller gear 40 via the intermeshing of the teeth 38a, 40a respectively gears 38, 40 in an intermeshing zone 42 beneath a nip 44 disposed between the two intermeshing gears. The gear drive output shaft 46 is mounted to the smaller gear 40.

The turbine housing 24 is mounted to gear housing 32, over the impeller 22. As impeller 22 spins, it drives air through the volute shape housing 24. Housing 24 aids in increasing the flow and compression of the airflow, output into the engine air intake 12.

In summary then, the large drive pulley 34a is mounted on the engine primary clutch 26b, or directly on the engine output shaft 26c, and turns drive belt 18. Drive belt 18 turns small drive pulley 34b. The small pulley 34b turns the input shaft 36 and the first drive gear 38. The first drive gear 38 spins the second drive gear 40, and acts to reverse and increase the revolutions of the impeller 22. The gear ratio may be approximately 3:1, although this in not intended to be limiting. The second drive gear 40 spins the output shaft 46 and impeller 22. Impeller 22 scavenges available outside ambient air, and accelerates and compresses the air through turbine housing 24. The air exits turbine housing 24 into the engine air intake system via air intake 12 airbox 14 which directs the compressed air flow to the combustion chamber 26a for each cylinder in engine 26. In particular, airbox 14 distributes the charge air from a single inlet (air intake 12) to the combustion ports of the cylinders.

The exhaust restriction assembly consists of exhaust flow restrictor 16. This flow restrictor 16 and an exhaust resonator 16a may be a one piece assembly that replaces the stock muffler, although this is not intended to be limiting. The exhaust resonator 16a may be a baffled bottle which quiets the exhaust from the engine. Flow restrictor 16 may be positioned in other places along the exhaust flow, for example either downstream of exhaust expansion chamber 48 as illustrated or upstream of expansion chamber 48.

The exhaust flow restrictor 16 slows the exhaust gases expelled in direction D from engine 26, while providing enough backpressure to ensure that the boost charge air is held in combustion chambers 26a until ignition thereby preventing “blow-through” of the unburnt fuel/air mixture in the combustion chamber. In one embodiment exhaust flow restrictor uses, an offset butterfly valve 50, although this is not intended to be limiting. Valve 50 is mounted on an axle which is transverse to flow direction D. Valve 50 is offset in the sense that one side of the valve plate extends a greater distance from the axle than the other side of the valve plate. Thus flow in direction D will open the valve. A bell crank arm is mounted to the axle. Spring 54 is mounted between the bell crank arm and an adjustably positionable base mounted to the exhaust pipe. The position of spring 54 along the length of the bell crank arm is also adjustable. Offset valve 50 opens by an amount which is relative to the volume of expelled gases from the engine. Thus valve 50 opens more under higher boost and RPM conditions. The minimum opening provided by valve 50 is controlled by a fully closed exhaust stop 52. Wide open stops 52a may also be provided. Spring 54 biases valve 50 closed and controls the rate at which the valve will open. A wide open throttle stop may also be provided. The relationships between, and positioning of, each of these components of the valve allow engine 26 to be tuned to specific boost pressures or engine management parameters, throughout the engine RPM range.

Gear housing 32 is composed of two mating halves, 32a and 32b. Mating half 32a and 32b are illustrated split apart for ease of understanding and the workings and lubrication of gear assembly 20. It is understood however that in operation the two mating halves 32a and 32b are mounted to each other in opposed facing relation so as to provide mirror image caps of gear cavity 38b in which is mounted gear 38 and of gear cavity 40b in which is mounted gear 40. Mating halves. 32a and 32b together also form oil reservoir 56, one half of which is shown formed in mating half 32b. Oil supply metering channel 56a in mating half 32b is capped by mating half 32a.

As gear 38 rotates in direction E on input shaft 36, oil from reservoir 56 is drawn through oil metering channel 56a and into gear cavity 38b. Teeth 38a on gear 38 act to pump oil around the circumferential segment of gear cavity 38b extending also in direction E from channel 56a to nip 44, so as to supply oil to lubricate teeth 38a and teeth 40a in intermeshing zone 42, teeth 40a rotating in direction G with gear 40 as gear 40 is driven by gear 38. In one embodiment channel 56a is approximately 100 thousands of an inch square in cross-section to meter the oil entering gear cavity 38b.

In order to maintain gear assembly 20 as a sealed self-contained unit not requiring external oil pumps, or additional oil-pumping gears as conventionally done, and so as to avoid the use of conventional oil pan arrangements which, unlike the present invention, limit the operational angle of inclination that may be sustained without damage due to failure of the oil circulation system in conventional oil circulating systems, the oil within gear assembly 20 must be re-circulated back to oil reservoir 56. The recirculation is most efficiently done by recapturing the oil as it is conveyed and migrates in direction E into nip 44 and thence in direction H into a re-capture channel 58. For oil which is conveyed by gear 40 in direction G past channel 58 so as to migrate around the circumferential wall segment of gear cavity 40b from the entrance 58a to channel 58 to the entrance 60a to channel 60, further oil is recaptured and flows in direction 1 into channel 60. Oil flowing through channels 58 and 60 is directed along smoothly contoured flow paths in channels 58 and 60 into oil reservoir 56.

Channels 58 and 60 are defined in part by the shape of island 62. Island 62 provides the concave wall of gear cavity 40b between the entrances 58a and 60a into channels 58 and 60 respectively. Sharp vertices 64a, 64b and 64c at, respectively, the junction of gear cavity 38b and entrance 58a, the junction of gear cavity 40b and entrance 58a, and the junction of gear cavity 40b and entrance 60a, provide a skimming function skimming oil from their respective gears 38 and 40 and directing oil into corresponding entrances 58a and 60a. Close tolerances of for example 20 thousandths of an inch between vertices 64a-64c and their respective gears 38, 40 assist in skimming off the oil from the gears.

To illustrate the importance of a correctly metered and recirculated oil supply within a self-contained gear assembly 20, consider the high RPM at which typically impeller 22 will operate. In one embodiment not intended to be limiting, the ratio between pulleys 34a and 34b is approximately 3:1. As stated above, pulley 34b drives gear 38 which in turn drives gear 40 on which impeller 22 is rigidly mounted. In one embodiment the ratio between gears 38 and 40 is approximately 3:1. Hence the overall gear-up ratio between the engine RPM and the impeller RPM is 9:1. With the engine operating at for example 5,000 RPM, impeller 22 will thus be spinning at 45,000 RPM. The importance of a properly metered oil supply is therefore evident. In applicant's experience, too great a flow rate of oil from channel 56a leads to hydraulic lock in the flow of oil, for example in nip 44 which causes a loss in efficiency, and too low a flow rate of oil from channel 56a leads to inadequate lubrication between gears 38 and 40 causing increased friction, over-heating, and pre-mature wear.

In order to assist the distribution of oil from the gear cavities in gear housing 32 to bearings 66 and 68, bores 66a and 68a are provided between, respectively, gear cavity 38a and bearings 66, and gear cavity 38a and bearings 68. Mirror image, or otherwise similar bores are formed in each of the gear housing mating halves 32a and 32b to supply oil to the corresponding bearings 66, 68, 66′ and 68′.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A system for supercharging a two stroke engine, the system comprising:
a) a supercharger adapted for mounting directly on to the two stroke engine and so as to cooperate therewith, said supercharger adapted to be driven directly from the crank of the engine, said supercharger having a gear case containing a gear train consisting of only first and second intermeshing gears, wherein said first gear is coupled to the engine crank when said supercharger is mounted on said engine and wherein a compressor is mounted within a compressor housing and said compressor housing is mounted on said gear case, said compressor coupled to said second gear for co-axial rotation therewith, said first and second gears intermeshing at a nip and a corresponding intermeshing zone therebetween, so that said first gear drives said second gear, said compressor mountable in fluid communication with an air intake of the engine,
wherein said gear case has first and second gear cavities overlapping at an overlap at said intermeshing zone, and wherein said first and second gears are mounted, respectively, in said first and second gear cavities, said first and second gear cavities sized for snug nesting of said first and second gears into said first and second cavities respectively,
wherein said gear case has an oil reservoir formed therein, and wherein said gear case further includes an oil metering conduit formed in fluid communication between said oil reservoir and said first gear cavity whereby oil in said reservoir flows into said first gear cavity, and wherein said rotation of said first gear conveys oil from said oil metering conduit around a circumferential segment of said first gear cavity to thereby convey the oil to said nip and through said intermeshing zone wherein said first gear is mated to said second gear, said gear case further formed to provide an oil skimmer and oil recirculating channels for recapturing and recirculating oil from said first and second gear cavities to said reservoir,
b) an exhaust flow restrictor adapted for mounting into an exhaust conduit of the engine, said flow restrictor adapted to regulate exhaust outflow through the exhaust conduit in response to exhaust volume and exhaust pressure from the engine, and wherein said exhaust flow restrictor is thereby adapted to provide a backpressure into the combustion chambers of the engine to inhibit blow-through into the exhaust of unburnt fuel/air mixture from the combustion chambers, where said blow-through is caused by boost pressure from said compressor into the air intake of the engine which is not counter-balanced by back pressure in the exhaust outflow.

2. The system of claim 1 wherein said first and second gear cavities and said oil reservoir are all substantially co-planar, and wherein said oil skimmer and said oil recirculating channels are substantially co-planar with said first and second gear cavities and said oil reservoir, and wherein at least a first oil recirculating channel of said oil recirculating channels extends in fluid communication between said first gear cavity and said oil reservoir,
and wherein said oil skimmer includes at least a first vertice, said first vertice at a vertex of a wall segment of said first gear cavity and an entrance to said first oil recirculating channel, said first vertice aligned pointed substantially in a first counter-flow direction relative to a forward flow direction of oil during said conveying of the oil in said first gear cavity under the influence of rotation of said first gear.

3. The system of claim 2 further comprising at least a second oil recirculating channel of said oil recirculating channels extends in fluid communication between said second gear cavity and said oil reservoir,

4. The system of claim 3 wherein said oil skimmer includes at least a second vertice, said second vertice at a vertex of a wall segment of said second gear cavity and an entrance to said second oil recirculating channel, said second vertice aligned pointed substantially in a second counterflow direction relative to a forward flow direction of oil during conveying of the oil in said second gear cavity under the influence of rotation of said second gear when driven by said rotation of said first gear.

5. The system of claim 4 wherein said entrances to said first and second oil recirculating channels are spaced apart, and wherein at least one of said entrances is located at said overlap.

6. The system of claim 5 wherein said entrance to said first oil recirculating channel is located at a downstream end of said overlap.

7. The system of claim 6 wherein said entrance to said first oil recirculating channel includes an opposite vertice, oppositely disposed to said first vertice on an opposite side of said entrance to said first oil recirculating channel, wherein said opposite vertice is formed along a wall segment of said second gear cavity.

8. The system of claim 4 wherein said first and second oil recirculating channels define an island therebetween, and wherein said island, and opposite side walls of said channels opposite to said island, form smoothly contoured flow paths for the oil.

9. The system of claim 8 wherein said channels converge from said entrances to opposite downstream ends of said channels, opposite said entrances, said downstream ends in fluid communication into said oil reservoir.

10. The system of claim 4 wherein said oil reservoir is located adjacent said first and second gear cavities, and wherein said oil metering conduit has an entrance port and an outflow port, said entrance port is located at said oil reservoir and said outflow port located at an upstream end of said wall segment of said first gear cavity, upstream relative to said forward flow direction in said first gear cavity, and wherein said oil metering conduit adjacent said outflow port is aligned substantially tangentially to said upstream end and so as to direct outflow of oil from said outflow port substantially tangentially to and in said forward flow direction in said first gear cavity.

11. The system of claim 10 wherein said oil metering conduit is substantially linear.

12. The system of claim 1 wherein said flow restrictor is a valve.

13. The system of claim 12 wherein said valve has an open and a closed position, and variable positions therebetween, and wherein, in said closed position, the exhaust outflow is minimized, and wherein, in said open position, the exhaust outflow is maximized and wherein said valve is positioned within said variable positions between said open and closed positions so as to timely provide said back pressure to inhibit said blow-through and to also allow timely outflow of the exhaust for aspiration of the engine.

14. The system of claim 13 wherein said valve is variably and automatically biased throughout a range of positions in said variable positions so as to automatically provide a variable said back-pressure in response to at least one engine output.

15. The system of claim 14 wherein said at least one output includes exhaust volume, flow rate and pressure.

16. The system of claim 15 wherein said valve is resiliently biased by a resiliently biasing force towards said closed position, and wherein the exhaust output urges said valve towards said open position against said return resiliently biasing force.

17. The system of claim 16 wherein adjustable stops are provided, adapted to be mounted to said exhaust conduit, so as to cooperate with said valve for selective adjustment of the range of said variable positions between said open and closed positions.

18. An apparatus for supercharging a two stroke engine, the system comprising a gear case containing a gear train consisting of only first and second intermeshing gears, wherein said first gear is adapted to be coupled to an engine crank of an engine when is mounted in a supercharger on said engine and wherein said second gear to be adapted for mounting to a compressor a compressor housing of the supercharger when said compressor housing is mounted on said gear case and the compressor coupled to said second gear for co-axial rotation therewith, said first and second gears intermeshing at a nip and a corresponding intermeshing zone therebetween, so that said first gear drives said second gear, said compressor mountable in fluid communication with an air intake of the engine,
wherein said gear case has first and second gear cavities overlapping at an overlap at said intermeshing zone, and wherein said first and second gears are mounted, respectively, in said first and second gear cavities, said first and second gear cavities sized for snug nesting of said first and second gears into said first and second cavities respectively,
wherein said gear case has an oil reservoir formed therein, and wherein said gear case further includes an oil metering conduit formed in fluid communication between said oil reservoir and said first gear cavity whereby oil in said reservoir flows into said first gear cavity, and wherein said rotation of said first gear conveys oil from said oil metering conduit around a circumferential segment of said first gear cavity to thereby convey the oil to said nip and through said intermeshing zone wherein said first gear is mated to said second gear, said gear case further formed to provide an oil skimmer and oil recirculating channels for recapturing and recirculating oil from said first and second gear cavities to said reservoir.

19. The apparatus of claim 18 wherein said first and second gear cavities and said oil reservoir are all substantially co-planar, and wherein said oil skimmer and said oil recirculating channels are substantially co-planar with said first and second gear cavities and said oil reservoir, and wherein at least a first oil recirculating channel of said oil recirculating channels extends in fluid communication between said first gear cavity and said oil reservoir,
and wherein said oil skimmer includes at least a first vertice, said first vertice at a vertex of a wall segment of said first gear cavity and an entrance to said first oil recirculating channel, said first vertice aligned pointed substantially in a first counter-flow direction relative to a forward flow direction of oil during said conveying of the oil in said first gear cavity under the influence of rotation of said first gear.

20. The apparatus of claim 19 further comprising at least a second oil recirculating channel of said oil recirculating channels extends in fluid communication between said second gear cavity and said oil reservoir,

21. The apparatus of claim 20 wherein said oil skimmer includes at least a second vertice, said second vertice at a vertex of a wall segment of said second gear cavity and an entrance to said second oil recirculating channel, said second vertice aligned pointed substantially in a second counterflow direction relative to a forward flow direction of oil during conveying of the oil in said second gear cavity under the influence of rotation of said second gear when driven by said rotation of said second gear when driven by said rotation of said first gear.

22. The apparatus of claim 21 wherein said entrances to said first and second oil recirculating channels are spaced apart, and wherein at least one of said entrances is located at said overlap.

23. The apparatus of claim 22 wherein said entrance to said first oil recirculating channel is located at a downstream end of said overlap.

24. The apparatus of claim 23 wherein said entrance to said first oil recirculating channel includes an opposite vertice, oppositely disposed to said first vertice on an opposite side of said entrance to said first oil recirculating channel, wherein said opposite vertice is formed along a wall segment of said second gear cavity.

25. The apparatus of claim 21 wherein said first and second oil recirculating channels define an island therebetween, and wherein said island, and opposite side walls of said channels opposite to said island, form smoothly contoured flow paths for the oil.

26. The apparatus of claim 25 wherein said channel converge from said entrances to opposite downstream ends of said channels, opposite said entrances, said downstream ends in fluid communication into said oil reservoir.

27. The apparatus of claim 21 wherein said oil reservoir is located adjacent said first and second gear cavities, and wherein said oil metering conduit has an entrance port and an outflow port, said entrance port is located at said oil reservoir and said outflow port located at an upstream end of said wall segment of said first gear cavity, upstream relative to said forward flow direction in said first gear cavity, and wherein said oil metering conduit adjacent said outflow port is aligned substantially tangentially to said upstream end and so as to direct outflow of oil from said outflow port substantially tangentially to and in said forward flow direction in said first gear cavity.

28. The apparatus of claim 27 wherein said oil metering conduit is substantially linear.

29. The system of claim 1 wherein said first and second gear cavities include bearing cavities for seating of bearings therein, and wherein bearing oil supply conduits extend from at least one of said gear cavities into said bearing cavities.

30. The apparatus of claim 18 wherein said first and second gear cavities include bearing cavities for seating of bearings therein, and wherein bearing oil supply conduits extend from at least one of said gear cavities into said bearing cavities.
